(19) United States
(12) Patent Application Publication
(10) Pub. No.: US 2010/0223596 A1
(43) Pub. Date: Sep. 2, 2010

(54) DATA PROCESSING DEVICE AND METHOD

(76) Inventors: Takeshi Inuo, Tokyo (JP); Kengo Nishino, Tokyo (JP); Nobuki Kajihara, Tokyo (JP)

Correspondence Address: Mr. Jackson Chen, 6535 N. STATE HWY 161, IRVING, TX, 75039, US

(21) Appl. No.: 12/681,402

(22) PCT Filed: Sep. 17, 2008
(86) PCT No.: PCT/JP2008/066763

§ 371 Date: Apr. 2, 2010

(30) Foreign Application Priority Data
Oct. 3, 2007 (JP) 2007-259889

(51) Int. Cl. G06F 9/44

(52) U.S. Cl. 717/108

(57) ABSTRACT

Based on a constriction condition of a parallel operation device which has been previously registered with data, a data processing device extracts a loop structure from a single-layer state transition graph structure of an object code input thereto, and converts the state transition graph containing a loop structure into a state transition on another layer, which is then output as a new object code.

### TECHNICAL FIELD

The present invention relates to a data processing device and method for generating object codes for operating a parallel operation device which comprises a programmable device such as an array of processors or the like for executing predetermined processing.

### BACKGROUND ART

Conventionally, a CPU (Central Processing Unit) has been known as a processor unit for implementing desired processing. Also, Japanese Patents No. 3576837, No. 3444216, No. 3269526, No. 3616518, No. 3674515, and No. 3528922 (which are hereinafter referred to as the first background art) describe parallel operation devices which comprise an arrayed processor that has a plurality of processors arranged in an array form for purposes of reducing the size and improving the performance.

A technology for generating a program (object code) which runs on this parallel operation device is described in Japanese Patent No. 3921367 (which is hereinafter referred to as the second background art).

In a parallel operation device of the first background art, processing is executed based on an object code which includes one or more pieces of configuration information which have been generated in accordance with data to be processed. Also, the first background art employs an approach for executing processing while directly specifying the location of configuration information stored in the parallel operation device. The configuration information refers to information required to virtually configure circuits within the parallel operation device, including operational instructions issued to processors, information indicative of a connection relationship between respective processors, and information indicative of a relationship between an event signal and configuration information which should be next selected in correspondence thereto. The object code refers to a collection of configuration information required to execute desired processing. An object code includes state transition graph information for a parallel operation device in a process for executing desired processing.

In the first background art where a plurality of object codes are installed in a parallel operation device, if pieces of configuration information included in these object codes are stored in overlapping locations, the object codes must be merged again such that they do not overlap each other. Also, when a plurality of object codes or a large scale object code is installed in a parallel operation device, the parallel operation device must execute processing such as abortion of processing, replacement of the object codes, resumption of the processing, and the like if such an object code includes a number of pieces of configuration information which exceeds the amount that can be held in the parallel operation device. Also, external processing devices such as a CPU are required for such processing. In this event, the parallel operation device according to the first background art can only store configuration information at storage locations which have been determined upon mergence of the object codes, so that even object codes comprised of configuration information associated with the same function must be respectively stored at storage locations assigned thereto. In other words, the parallel operation device must hold a plurality of pieces of the same configuration information, thus giving rise to a problem that unnecessary processing occurs, such as rewriting the same configuration information with each other.

Accordingly, the present applicant has proposed a parallel operation device which is capable of eliminating limitations in locations to which pieces of configuration information are stored, and sharing the configuration information (Japanese Patent Application No. 2007-061934 which is hereinafter referred to as the third background art).

FIG. 1 shows an exemplary configuration of a main portion, where the third background art is applied to the parallel operation device according to the first background art. Also, FIG. 2 is a timing chart representing the operation of the parallel operation device shown in FIG. 1.

In the configuration shown in FIG. 1, as a processing unit outputs an event signal, a state management unit converts a current state real number into a next state logic number based on the event signal, and a configuration number conversion unit converts the next state logic number to a next state real number. Since these processing steps must be performed in sequence, they cannot be executed in pipeline processing.

Thus, the configuration shown in FIG. 1 presents a present in which there is a large delay in changing from the current state to the next state (state transition) in the state management unit, which makes it difficult to perform processing at high speeds. This is because a clock cycle must be set long such that processing to execute state transition (state transition processing) is completed within one clock cycle in the state management unit. The clock cycle need not be set long if the state management unit is configured to process a state transition in a plurality of clock cycles. However, since the processing unit must wait for the completion of state transition processing after it has completed its own processing in one clock cycle, this thus causes degradation in processing performance.

To solve such a problem, the third background art proposes a parallel operation device which is provided with a state management unit and an auxiliary control unit, such that state transitions can be controlled at multiple layers by the state management unit and auxiliary control unit. However, since the parallel operation device basically differs from a normal CPU and the like in both structure and operation, no technologies have been established for appropriately generating an object code for such multi-layer state transitions or parallel operation processing utilizing the same.

Specifically, an object code for the parallel operation device according to the first background art can be generated from a source code by the second background art, but no technologies have been established for generating an object code for satisfactorily operating a parallel operation device, implemented by the parallel operation device according to the third background art, based on an object code provided by the second background art (hereinafter referred to as the initial object code).

### SUMMARY

It is therefore an object of the present invention to provide a data processing device and method which are capable of generating an object code for a parallel operation device which is configured to have the ability to control multi-layer state transitions.

To achieve the above object, a data processing device according to an aspect of the present invention is provided for generating an object code supplied to a parallel operation device which comprises a plurality of processors and a cross connection unit for switching connections of the processors, where the parallel operation device is configured to execute a plurality of processing operations in parallel in accordance with the object code comprised of operational instructions for the processors and at least one piece of configuration information including information indicative of a connection relationship of the processors, the data processing device comprising:

condition storage means for holding a constriction condition corresponding to a physical structure and physical properties of the parallel operation device; and

object code conversion means for generating an object code comprised of multi-layer state transitions from the object code comprised of single-layer state transitions based on the constriction condition.

A data processing method according to an aspect of the present invention, in turn, is provided for generating an object code supplied to a parallel operation device which comprises a plurality of processors and a cross connection unit for switching connections of the processors, where the parallel operation device is configured to execute a plurality of processing in parallel in accordance with the object code comprised of operational instructions for the processors and at least one piece of configuration information including information indicative of a connection relationship of the processors, the data processing method comprising:

holding a constriction condition corresponding to a physical structure and physical properties of the parallel operation device in condition storage means; and

generating an object code comprised of multi-layer state transitions from the object code comprised of single-layer state transitions based on the constriction condition.

### BRIEF DESCRIPTION OF THE DRAWINGS

FIG. 1 is a block diagram showing the configuration of a main portion in a parallel operation device according to the third background art.

FIG. 2 is a timing chart showing the operation of the parallel operation device shown in FIG. 1.

FIG. 3 is a block diagram showing an exemplary configuration of a data processing system according to the present invention.

FIG. 4 is a block diagram showing an exemplary configuration of a parallel operation device shown in FIG. 3.

FIG. 5 is a block diagram showing an exemplary configuration of a data processing device shown in FIG. 3.

FIG. 6 is a block diagram showing the configuration of object code conversion means shown in FIG. 3 according to a first embodiment.

FIG. 7 is a flow chart showing a processing procedure for a group candidate extraction means shown in FIG. 6.

FIG. 8 is a flow chart showing a processing procedure for a macro state transition generation means shown in FIG. 6.

FIG. 9 is a block diagram showing the configuration of object code conversion means shown in FIG. 3 according to a second embodiment.

FIG. 10 is a flow chart showing a processing procedure for preload information generation means shown in FIG. 9.

FIG. 11 is a state transition diagram showing an exemplary initial state transition graph included in an initial object code.

FIG. 12 is a schematic diagram showing an exemplary state transition list included in an initial object code.

FIG. 13 is a table showing an exemplary loop list and loop information extracted from the state transition list shown in FIG. 12.

FIG. 14 is a table showing an exemplary loop list and pseudo-loop information generated from the initial state transition graph shown in FIG. 11 and a state transition probability.

FIG. 15 is a table showing an exemplary prioritized loop list generated from the loop list shown in FIG. 13.

FIG. 16 is an exemplary table of a group list for each state generated from the loop list shown in FIG. 15.

FIG. 17 is a state transition diagram illustrating a process of generating a macro state transition graph.

FIG. 18 is a state transition diagram showing an exemplary macro state transition graph generated from the group list shown in FIG. 16.

FIG. 19 is a table showing exemplary preload information generated from the per-state group list shown in FIG. 16 and the macro state transition graph shown in FIG. 18.

FIG. 20 is a timing chart showing how parallel operation device 140 shown in FIG. 3 operates.

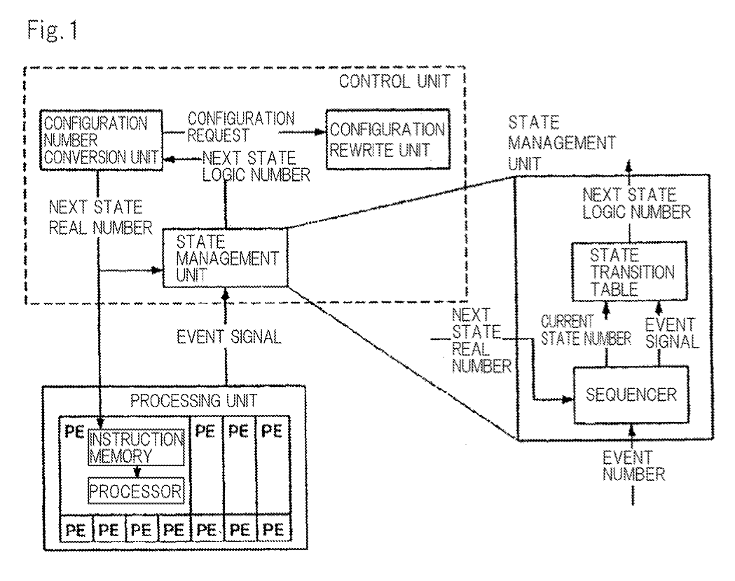

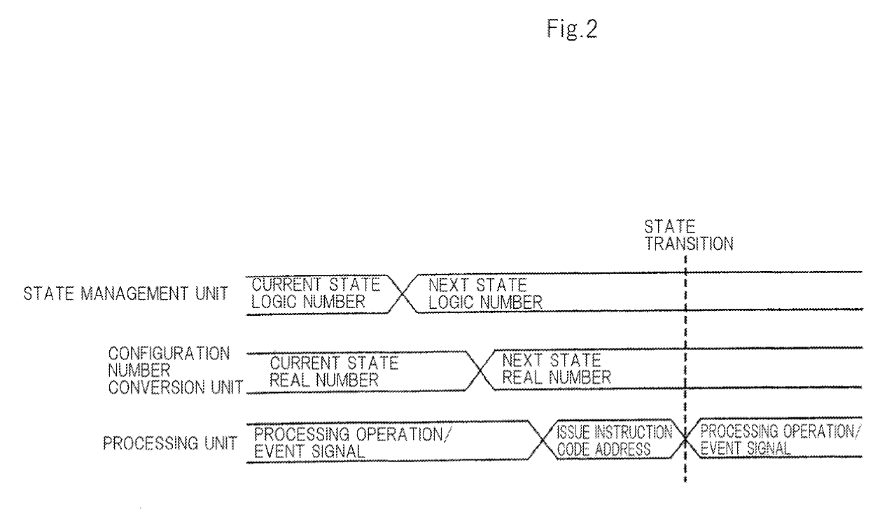

### EXEMPLARY EMBODIMENT

Next, the present invention will be described with reference to the drawings.

### First Embodiment

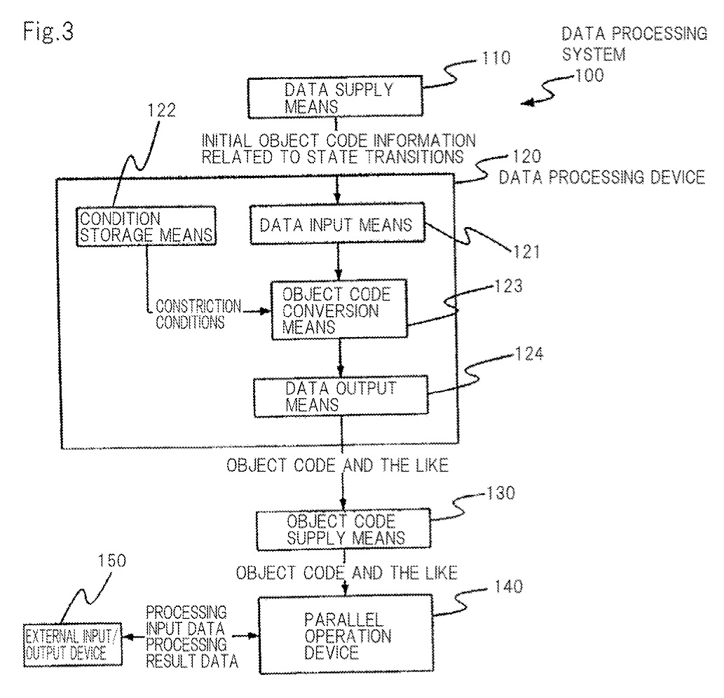

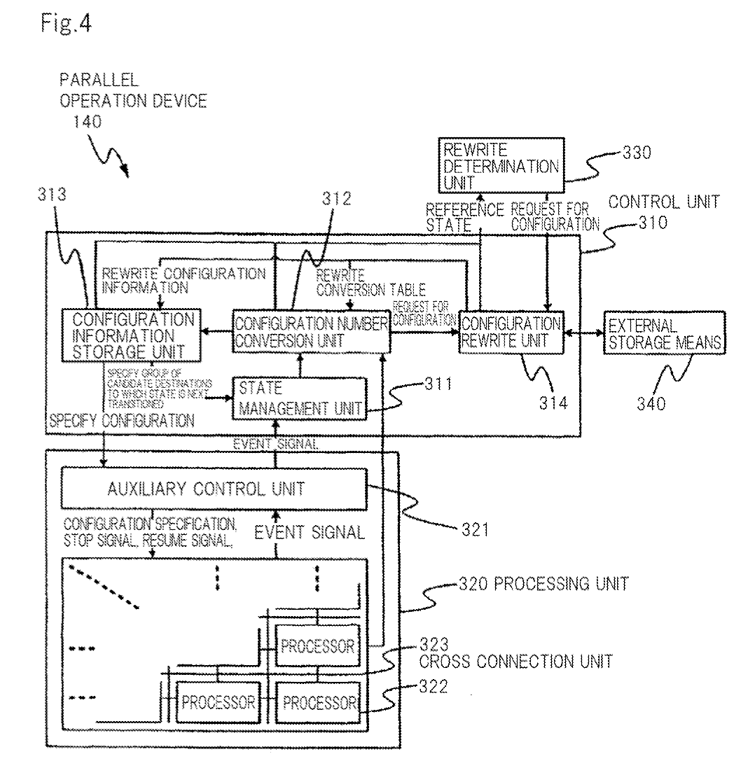

FIG. 3 is a block diagram showing an exemplary configuration of a data processing system according to the present invention, and FIG. 4 is a block diagram showing an exemplary configuration of a parallel operation device shown in FIG. 3.

Data processing system 100 shown in FIG. 3 comprises data supply means 110, data processing device 120, object code supply means 130, parallel operation device 140, and external input/output device 150.

As shown in FIG. 4, parallel operation device 140 comprises control unit 310, processing unit 320, rewrite determination unit 330, and external storage means 340.

Control unit 310 comprises state management unit 311, configuration number conversion unit 312, configuration information storage unit 313, and configuration rewrite unit 314.

Processing unit 320 comprises auxiliary control unit 321, a plurality of processors 322, and cross connection unit 323 for switching connections of respective processors 322.

Processors 322 and cross connection unit 323 operate in accordance with an object code which comprises at least one piece of configuration information which includes operational instructions for processors 322, and information indicative of a connection relationship of cross connection unit 323.

Configuration information storage unit 313 holds at least part of the configuration information in the object code, and information on candidates of states to which a transition is to be next made, and supplies the held information to auxiliary control unit 321 and state management unit 311.

External storage means 340 holds the object code, and also holds information required for processing which is to be executed by parallel operation device 140.

State management unit 311 specifies a logic number which is information indicative of a mutual relationship between respective pieces of configuration information included in the object code, among those pieces of configuration information to be used in the next operation state, based on a current operation state, the candidates of states to which a transition is to be next made, and event information issued by processors 322.

Auxiliary control unit 321 is interposed between processors 322 and cross connection unit 323 and state management unit 311 for controlling state transitions which are smaller in scale than those state transitions which can be controlled by state management unit 311.

Configuration number conversion unit 312 converts a logic number into a real number indicative of a storage location at which configuration information corresponding to the logic number is actually preserved. In this event, if configuration information corresponding to a logic number is not held in configuration information storage unit 313, a request is made to configuration rewrite unit 314 to rewrite configuration information so that it corresponds to the logic number.

Configuration rewrite unit 314 reads information such as an object code from external storage means 340, and rewrites information held by configuration information storage unit 313 or configuration number conversion unit 312 with the read information, in response to a request from configuration number conversion unit 312 or from rewrite determination unit 330.

Rewrite determination unit 330 references current states of configuration number conversion unit 312, configuration information storage unit 313, and configuration rewrite unit 314, included in control unit 310, predicts configuration information which may be required in states subsequent to a state to which a transition is next made, and requests configuration rewrite unit 314 to rewrite the configuration information.

Parallel operation device 140 in this embodiment executes a plurality of processing in parallel through a state transition which is made for every operation cycle corresponding to the object code stored in external storage means 340 by auxiliary control unit 321 and state management unit 311, and through assignment of processing of respective processors 322 corresponding to this state transition and a connection relationship of cross connection unit 323 from configuration information storage unit 313.

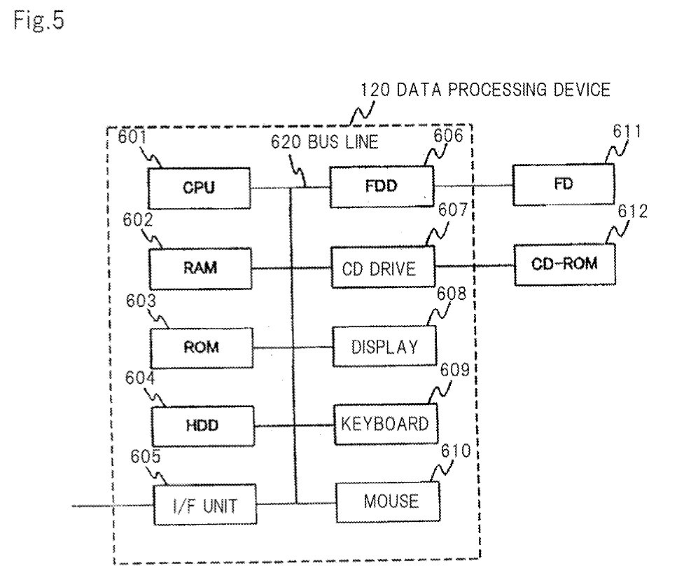

Data processing device 120 according to this embodiment can be implemented by a computer which comprises CPU 601, RAM 602, ROM 603, HDD 604, FDD (FD Drive) 606 into which FD 611 is exchangeably loaded, CD drive 607 into which CD-ROM 612 is exchangeable loaded, display 608, keyboard 609, mouse 610, I/F unit 605 and the like, which are all connected to CPU 601 through bus line 620, for example, as shown in FIG. 5.

In data processing device 120 in this embodiment, RAM 602, ROM 603, HDD 604, FD 611, CD-ROM 612 and the like correspond to recording media, and at least one of these recording media has stored thereon programs for executing processing on CPU 601, and a variety of data.

For example, programs for causing CPU 601 to execute a variety of processing have been previously stored in FD 611 or CD-ROM 612. Such programs have been previously installed in HDD 604, and are copied into RAM 602 after data processing device 120 has been turned on and CPU 601 has read the programs.

CPU 601 reads proper programs to execute a variety of processing in this manner, thereby causing data processing device 120 in this embodiment to operate as data input means 121, condition storage means 122, object conversion means 123, and data output means 124, shown in FIG. 3.

Data supply means 110 of data processing system 100 comprises, for example, FD 611 which has stored thereon an initial object code and information related to state transitions, and supplies data processing device 120 with the initial object code and the information related to state transitions of parallel operation device 140. Here, the information related to state transitions may include the probably at which state transitions may occur at a branch, and the like. The initial object code comprises single-layer state transitions.

Data input means 121 of data processing device 120 is implemented by CPU 601 which controls FDD 606 in accordance with a program stored in RAM 602. Data input means 121 acquires the initial object code and information related to state transitions stored in data supply means 110.

Condition storage means 122 is implemented by a storage area of HDD 604 or the like which is recognized by CPU 601 in accordance with a program. Condition storage means 122 has been previously registered with a variety of constriction conditions corresponding to the physical structure, physical properties and the like of parallel operation device 140.

Object code conversion means 123 is implemented by CPU 601 which executes processing in accordance with a program. Object code conversion means 123 converts the initial object code and information related to state transitions acquired through data input means 121 into an object code comprised of multi-layer state transitions for more efficiently operating parallel operation device 140, based on the constriction conditions stored in condition storage means 122.

Data output means 124 is implemented by CPU 601 which controls data output of I/F unit 605 in accordance with a program. Data output means 124 outputs the object code converted by object code conversion means 123 to object code supply means 130.

Object code supply means 130 is comparable to a connector (not shown) or the like for connecting I/F unit 605 of data output means 124 with external storage means 340 of parallel operation device 140, and stores the object code output from data processing device 120 in external storage means 340 of parallel operation device 140.

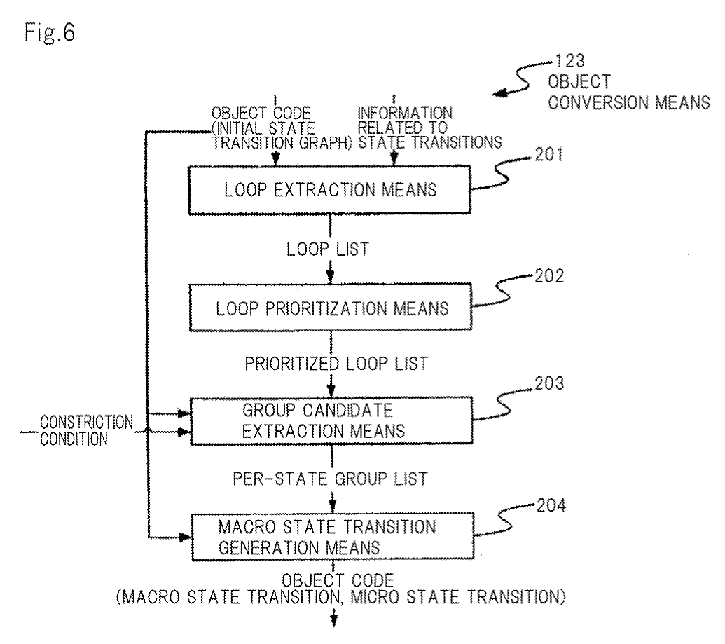

Object code conversion means 123 included in data processing device 120 of this embodiment comprises loop extraction means 201, loop prioritization means 202, group candidate extraction means 203, and macro state transition generation means 204, as shown in FIG. 6.

Loop extraction means 201 analyzes information related to an initial state transition graph and state transitions included in an initial object code input thereto, extracts loop structures of states, and generates a list of the loop structures (loop list). The information related to state transitions includes, for example, a state transition list which can be created by causing parallel operation device 140 or a simulator or the like, which operates in a similar manner to parallel operation device 140, to operate the initial object code, a transition probability on a state-by-state basis, and the like. When no such information related to state transitions is available, a transition probability may be appropriately set beforehand, based on the structure of the initial state transition graph, for example, assigning the same probability to all transitions from a certain state.

The loop list contains at least one piece of loop information related to individual loops, for example, the number of states included in a loop, combinations or permutations of states along the loop, an average number, a maximum number, or a minimum number of operation cycles which have occurred or which are predicted to occur in the loop, transition probabilities, and the like.

Loop prioritization means 202 gives priorities to respective loop lists generated by loop extraction means 201 based on the loop information, and generates a prioritized loop list.

The priorities are given using one or more items of information included in the loop information from among, i.e., the number of states in a loop, the average number, the maximum number and a minimum number of operation cycles which have occurred or are predicted to occur in the loop.

Group candidate extraction means 203 generates a group list on a state-by-state basis from the prioritized loop list, based on the initial state transition graph included in the initial object code and the constriction conditions.

The constriction conditions, which vary depending on the physical structure, physical properties and the like of parallel operation device 140, include, for example, the amount of data on configuration information which can be held in configuration information storage unit 313 of parallel operation device 140, the number of states which can be held in auxiliary control unit 321 or state management unit 311, the number of conversion tables which can be held in configuration number conversion unit 312, the time taken by configuration rewrite unit 314 to rewrite configuration information and conversion tables, the time taken for internal processing of auxiliary control unit 321, state management unit 311 and configuration number conversion unit 312, the time taken for controlling auxiliary control unit 321, state management unit 311 and configuration number conversion unit 312, and the like.

A per-state group list generated by group candidate extraction means 203 enumerates a state number which includes a pertinent state for each node (each state) of an initial state transition graph.

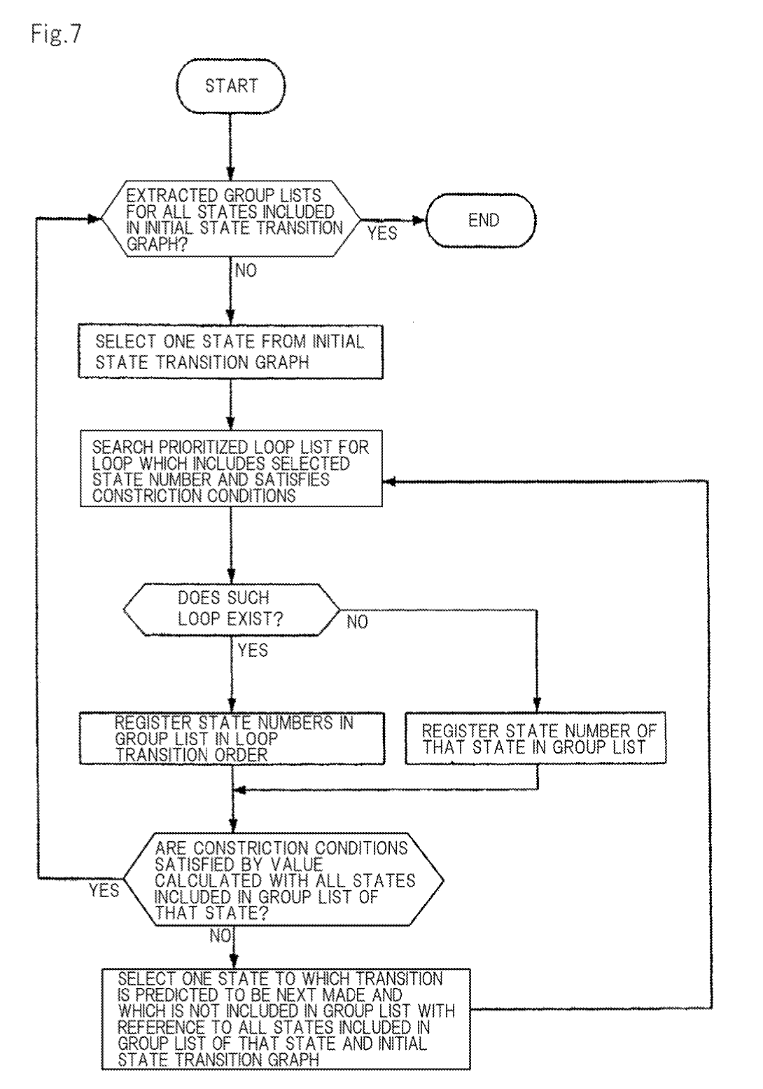

FIG. 7 shows, in a flow chart form, a processing procedure for group candidate extraction means 203 to generate a group list.

As shown in FIG. 7, group candidate extraction means 203 generates a group list for all nodes (states) of an initial state transition graph. Group candidate extraction means 203 first searches the prioritized loop list, in descending order, for those loops which include state numbers of all states selected from the initial state transition graph and which satisfy a constriction condition. The constriction condition used herein is the number of states which can be held in auxiliary control unit 321, or the like. For example, if the number of states which can be held in auxiliary control unit 321 exceeds the number of states included in a loop, state transitions cannot be controlled by auxiliary control unit 321, so that a search must be made for a loop which is made up of a number of states equal to or less than this number. In this event, it is preferable to select, for example, a loop which includes a least possible number of states, and which takes a longer time for rewriting configuration information in configuration rewrite unit 314 than the average number of operation cycles which have occurred or which are predicted to occur within the loop, which is a constriction condition, later described. If such a loop is present, state numbers are registered in a group list in the order of state transitions of the loop. If such a loop is not present, selected state numbers are registered in the group list.

Next, group candidate extraction means 203 determines whether or not the constriction conditions are satisfied by values calculated in correspondence to all states included in the group list, for example, an average number of operation cycles which have occurred or which are predicted to occur within a loop included in a group list of a selected state, a total number of states included in the group list, and the like. When satisfied, group candidate extraction means 203 terminates the registration of the group list for this state, and repeats the foregoing processing for a state which has not been extracted from the group list When not satisfied, group candidate extraction means 203 selects one state not included in this group list, to which a transition is predicted to be next made, with reference to all states included in the group list for the selected state and the initial state transition graph, repeats the processing from the aforementioned loop search for the selected state, and additionally registers a retrieved state number in this group list.

Group candidate extraction means 203 of this embodiment employs the next two conditions as the constriction condition in this particular example:

(1) the total number of states included in a group list is equal to or less than the number of states which can be held in auxiliary control unit 321, and is as small as possible; and

(2) the average number of operation cycles which have occurred or which are predicted to occur within a loop included in a group list of a selected state is larger than a predetermined value.

This is because a period in which configuration rewrite unit 314 rewrites configuration information predicted by rewrite determination unit 330 of parallel operation device 140 causes processor 320 to be inoperative and parallel operation device 140 to degrade in processing performance, when a time taken for configuration rewrite unit 314 to rewrite configuration information is larger than an average number of operation cycles which have occurred or which are predicted to occur in a loop included in a group list of a selected state.

Notably, condition (1) is given a higher priority out of the two conditions.

Macro state transition generation means 204 generates an object code comprised of multi-layer state transitions (macro state transition graph, micro state transition graph) from the per-state group list for allowing parallel operation device 140 to more efficiently operate, based on the initial state transition graph included in the initial object code input thereto.

In this regard, macro states refer to those states which are sequentially transitioned by the control unit of parallel operation device 140, while micro states refer to those states which are sequentially transitioned by the auxiliary control unit of parallel operation device 140.

A micro state transition graph is a partial graph within an initial state transition graph, mainly comprised of states which are registered in the per-state group list, and there are one or more micro state transition graphs. A macro state transition graph is a graph which indicates transitions between micro state transition graphs, and there is only one macro state transition graph.

Macro state transition generation means 204 performs covering of the initial state transition graph using a group list to generate an object code comprised of multi-layer state transitions (macro state transition graph, micro state transition graph) for allowing the parallel operation device to operate more efficiently.

Covering refers to making up a certain graph with a combination of partial graphs thereof, and the macro state transition generation means performs the covering of the initial state transition graph with micro state transition graphs to generate the macro state transition graph. In this event, nodes on the macro state transition graph are the micro state transition graphs.

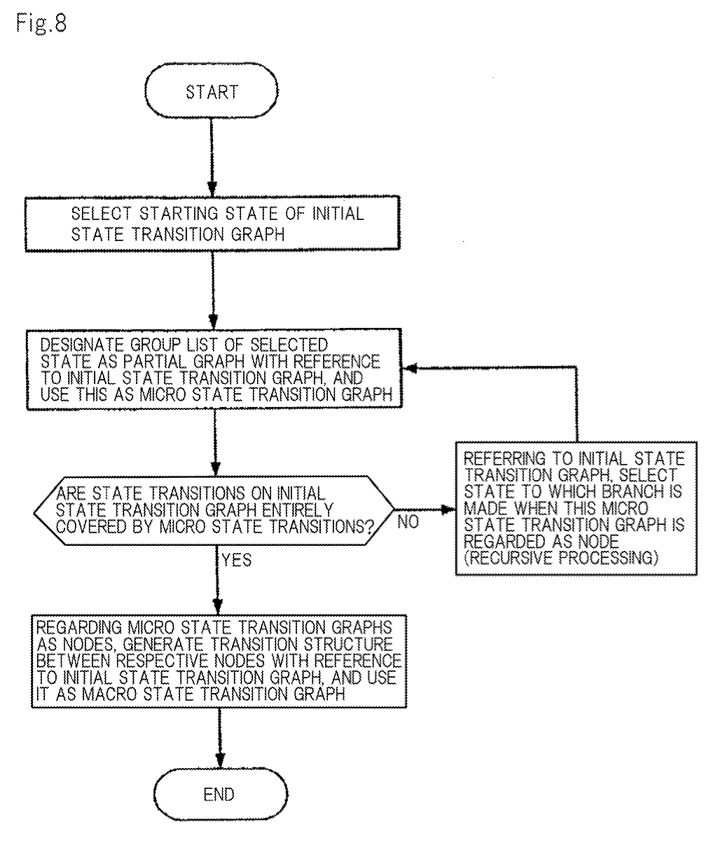

FIG. 8 shows, in a flow chart form, a processing procedure for macro state transition generation means 204 to generate the macro state transition graph and micro state transition graph.

As shown in FIG. 8, macro state transition generation means 204 first selects a starting state of the initial state transition graph, references a group list of this selected state, and generates a partial graph of the initial state transition mph with a plurality of states included in the referenced group list. Macro state transition generation means 204 designates this partial graph as one micro state transition graph.

Next, macro state transition generation means 204 determines whether or not the micro state transition graphs that have been generated so far presents an area which could not have been covered even with part of the initial state transition graph. When there is an area which could not have been covered even with part of the initial state transition graph, macro state transition generation means 204 selects a state which is positioned at the destination of the next branch, when it regards a micro state transition graph generated with reference to the initial state transition graph as a node, and repeats the foregoing processing until the micro state transition graphs cover the entire initial state transition graph. Here, the foregoing processing involves recursive processing because there are a plurality of states which are positioned at destinations of a next branch when a micro state transition graph is regarded as a node.

Macro state transition generation means 204 regards micro state transition graphs as nodes when the initial state transition graph is entirely covered with the micro state transition graphs, and generates a transition structure between these nodes with reference to the initial state transition graph, and uses the transition structure as a macro state transition graph.

According to data processing system 100 of this embodiment, micro state transition graphs including a prioritized loop structure, are extracted from the initial object code by object code conversion means 123, and are controlled by auxiliary control unit 321 of parallel operation device 140. Then, a macro state transition graph, which represents transition information between the micro state transition graphs, is controlled by state management unit 311 of control unit 310. Accordingly, auxiliary control unit 321 is involved in a larger number of operation cycles, as compared with the case where parallel operation device 140 operates in accordance with the initial object code, thus making it possible to relatively reduce the proportion of an operation interrupted time of processor 320, associated with processing performed by way of state management unit 311. Consequently, the processing performance of parallel operation device 140 is improved.

### Second Embodiment

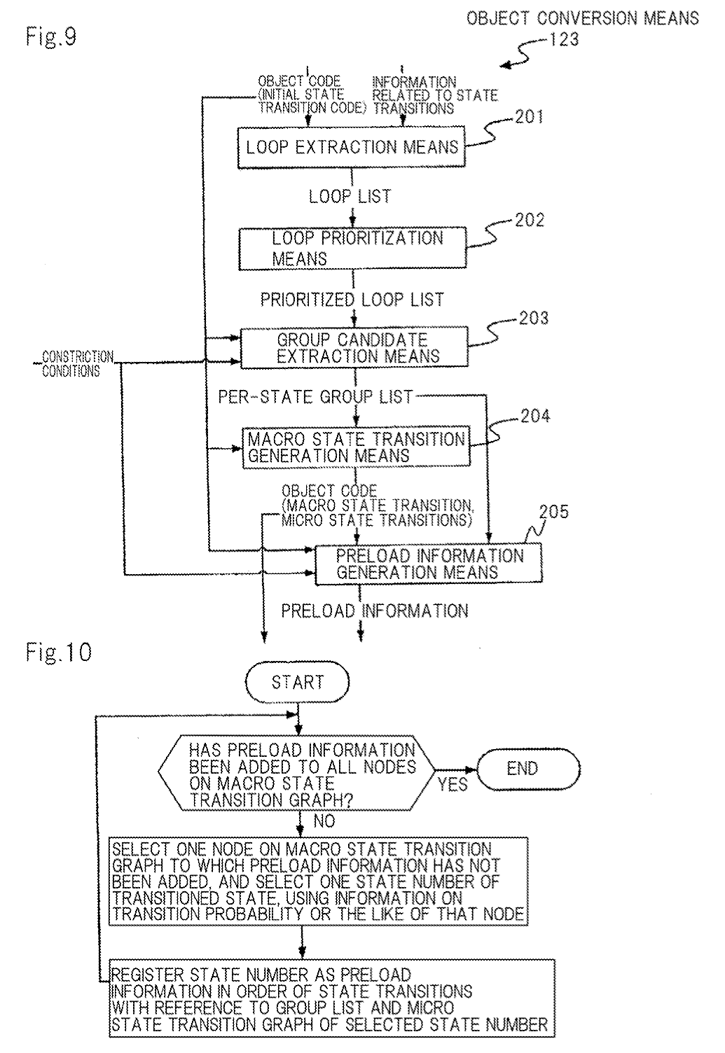

FIG. 9 is a block diagram showing the configuration of object code conversion means 123 shown in FIG. 3, according to a second embodiment.

Object code conversion means 123 in the second embodiment comprises preload information generation means 205 which is added at a stage subsequent to macro state transition generation means 204 included in object code conversion means 123 in the first embodiment. The remaining configuration is similar to that of the first embodiment, so that a description thereof is omitted.

Preload information generation means 205 generates preload information based on an initial state transition graph, a group list output on a state-by-state basis from group candidate extraction means 203, a macro state transition graph and micro state transition graph(s) output from macro state transition generation means 204, and constriction conditions. Preload refers to processing to notify configuration rewrite unit 314 in parallel operation device 140 of configuration information required in states subsequent to a state to which a transition is next made, when configuration information storage unit 313 does not store configuration information corresponding to a state number to which a transition is next made, which has been determined by state management unit 311 of parallel operation device 140.

The preload information includes an indication for configuration information required by auxiliary control unit 321 and state management unit 311 in states subsequent to a state to which a transition is next made, in accordance with an operating condition of parallel operation device 140 for each node on each macro state transition.

FIG. 10 shows, in flow chart form, a processing procedure for preload information generation means 205 to generate preload information.

Preload information generation means 205 generates preload information corresponding to all nodes on a macro state transition graph. Preload information generation means 205 uses the constriction condition, and information on a transition probability for a node of interest on the macro state transition graph, selects one state number which is the destination to which the node (state) transitions, and registers the state number as preload information in the order of state transitions with reference to a group list and a micro state transition graph associated with the selected state number. Here, the information on a transition probability for a node on the macro state transition graph means, for example, a transition probability or the like for a state on the initial state transition graph corresponding to a state to which the node branches.

Also, the constriction condition used herein is the number of states which can be held in auxiliary control unit 321, or the like. For example, with this constriction condition, the total of the number of states included in the micro state transition graphs and the number of states registered in the preload information cannot exceed the number of states which can be held in the auxiliary control unit 321.

The preload information generated by object code conversion means 123 in this embodiment includes a state number corresponding to configuration information of a node to which a transition has been predicted to be next made, as additional information on each node on the macro state transition graph. Thus, by inputting this preload information to rewrite determination unit 330 of parallel operation device 140, rewrite determination unit 330 can request configuration rewrite unit 314 for configuration information required in states next to the state of state management unit 311 onward, in advance of an event signal from processing unit 320, during an operation cycle by auxiliary control unit 321, as compared with parallel operation device 140 according to the first embodiment. Consequently, the processing performance of parallel operation device 140 can be further improved.

### Examples

Next, examples of data processing device 120 according to the present invention will be described with reference to the drawings.

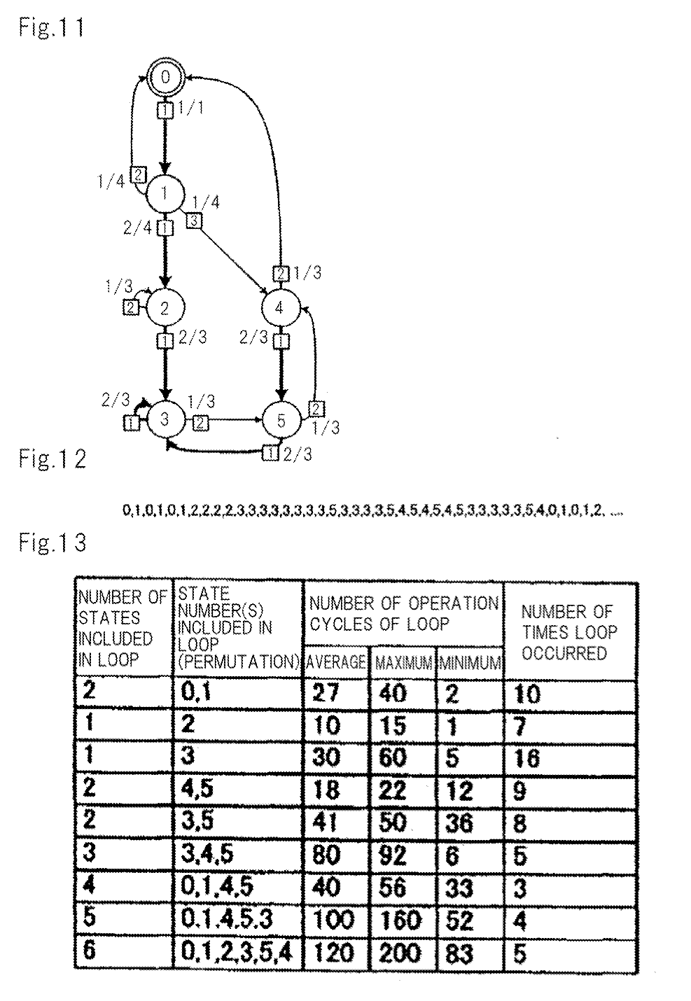

FIG. 11 shows an exemplary initial state transition graph included in an initial object code supplied from data supply means 110. A number written in each node on the initial state transition graph of FIG. 11 indicates a state number, a number of a branch indicates an event number, and a fractional value written beside a branch indicates the occurrence probability of this branch. The initial state transition graph presents state “0” in an initial state.

Notably, the occurrence probabilities at the branches shown in FIG. 11 are information related to state transitions supplied from data supply means 110. Other information related to state transitions may be, for example, a state transition list as shown in FIG. 12. This state transition list is a list of state transitions which can be provided by running the initial object code using, for example, parallel operation device 140 or a simulator or the like which operates in a manner similar to parallel operation device 140.

Loop extraction means 201 generates a loop list based on the initial state transition graph and the information related to the state transitions.

FIG. 13 shows an exemplary loop list and loop information extracted by loop extraction means 201 from the state transition list as shown in FIG. 12.

The table shown in FIG. 13 includes the number of states included in a loop, the state number sequence which denotes state numbers included in the loop in an order along the loop, the average value, the maximum value, and a minimum value of the number of operation cycles of the loop, and the number of times the loop occurred. Notably, FIG. 13 does not describe a loop comprised of states “0,” “1,” “4,” which means that such a loop is not included in the state transition list. When the state transition list is not available, pseudo-loop information may be generated from the state transition probabilities.

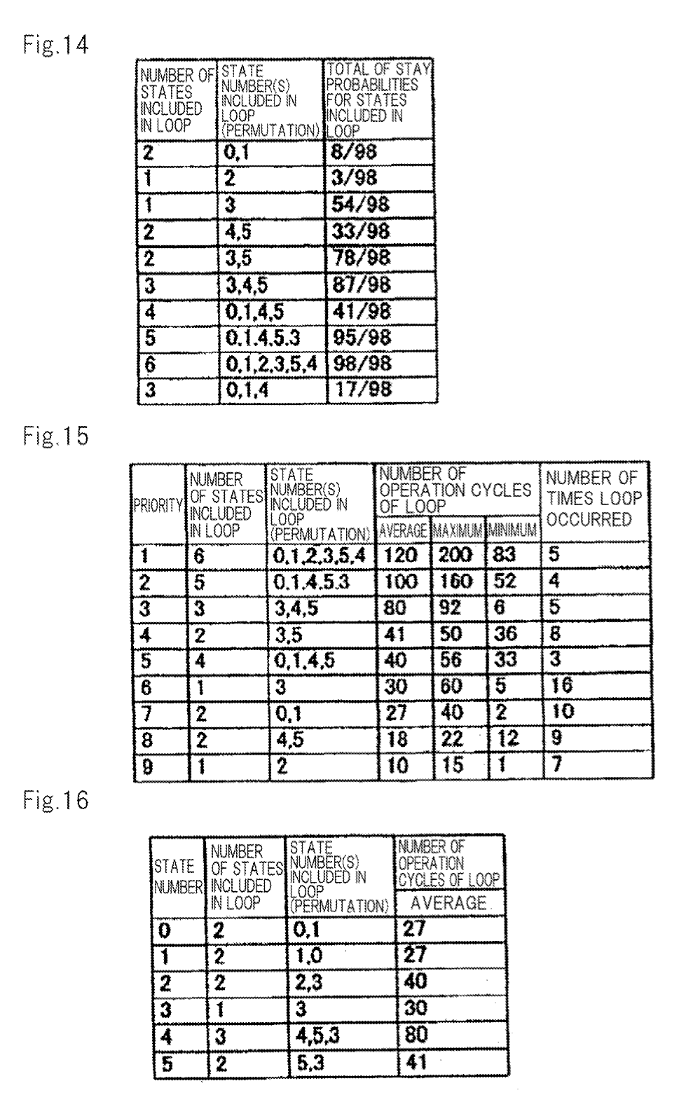

FIG. 14 shows an exemplary loop list and pseudo-loop information generated from the initial state transition graph and state transition probabilities shown in FIG. 11.

FIG. 14 shows an example where a stay probability is calculated for each state from the initial state transition graph and state transition probabilities, and the sum of stay probabilities of the states included in a loop is used as loop information. If neither the state transition list nor transition probabilities are available, the transition probability at each state of the initial state transition graph may be divided by the number of branches in that state, to employ the resulting value as the state transition probability. The state transition probability generated in this manner can be converted into pseudo-loop information, as described above.

Loop prioritization means 202 gives a priority to each loop list based on the loop information included in the loop list to generate a prioritized loop list.

FIG. 15 shows an exemplary prioritized loop list generated from the loop list shown in FIG. 13. In the prioritized loop list shown in FIG. 15, each loop list is given a priority, among the loop information, based on an average value of the number of operation cycles for a loop.

Group candidate extraction means 203 generates a per-state group list based on the initial state transition graph and constriction conditions included in the initial object code, using the prioritized loop list.

FIG. 16 shows an exemplary per-state group list generated from the loop list shown in FIG. 15. The group list shown in FIG. 16 is an example generated with the constriction conditions, including “4” chosen for the number of states which can be held in auxiliary control unit 321, and “20” chosen for an average number of operation cycles which have occurred or which are predicted to occur within a loop, which is comparable to a time taken by configuration rewrite unit 314 to rewrite configuration information.

The per-state group list shown in FIG. 16 includes a number of states included in the group list, which is a largest possible number equal to or less than “4” which is a constriction condition, and the average number of operation cycles which have occurred or which are predicted to occur in all states included in the group list is equal to or more than “20” which is a constriction condition.

Macro state transition generation means 204 generates an object code comprised of multi-layer state transitions (macro state transition graph, micro state transition graph(s)) for use by parallel operation device 140 from the per-state group list, based on the initial state transition graph included in the input initial object code.

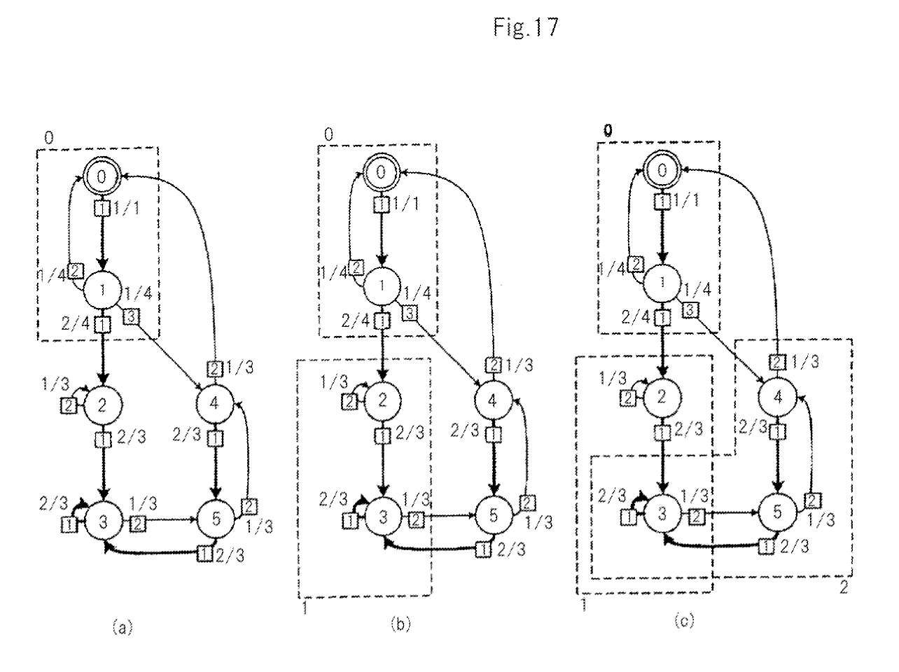

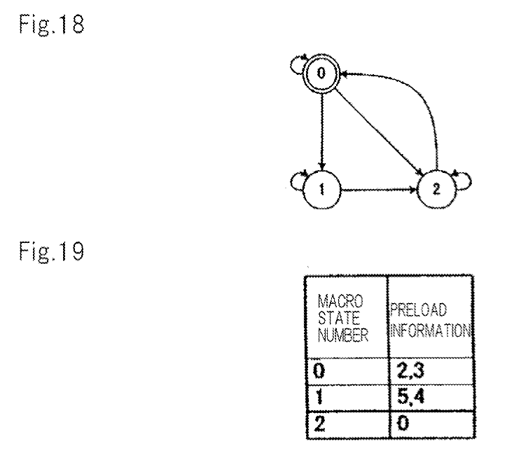

FIGS. 17(a)-17(c) are state transition diagrams which illustrate a process for generating a macro state transition graph. FIG. 18 is a state transition diagram showing an exemplary macro state transition graph generated from the group list shown in FIG. 16.

FIG. 17(a) shows an example which involves first focusing attention on state “0,” which is an initial state, extracting a group of states having state numbers “0” and “1” with reference to state number “0” from a group list, and creating a partial graph comprised of these state numbers “0” and “1” for use as a micro state transition graph for macro state number “0.”

FIG. 17(b) shows an example which involves first performing processing similar to the foregoing for state number “2” to extract a group of states designated by state numbers “2” and “3,” because state numbers “2” and “4” branch from macro state number “0,” and creating a partial graph comprised of these state numbers “2” and “3” for use as a micro state transition graph for macro state number “1.”

FIG. 17(c) shows an example which involves performing processing similar to the foregoing for state number “4” branching from macro state number “0” to extract a group comprised of state numbers “4,” “5,” “3,” and creating a partial graph comprised of these state numbers “4,” “5,” “3” for use as a micro state transition graph for macro state number “2.”

Since the initial state transition is completely covered by a combination of the micro state transition graphs shown above, macro state transition generation means 204 generates a macro state transition graph which is made up of nodes that have been generated so far and which is branches implemented by transitions between the micro state transition graphs.

Preload information generation means 205 generates preload information from the initial state transition graph, the per-state group list output from group candidate extraction means 203, the macro state transition graph and micro state transition graphs output from macro state transition generation means 204, and the constriction conditions.

FIG. 19 shows exemplary preload information which is generated from the per-state group list shown in FIG. 16 and the macro state transition graph shown in FIG. 18.

In FIG. 19, macro state number “2” only has state number “0” as preload information because the number of states included in macro state number “2” is “3.” From this, the number of preloaded states is limited to one in order to satisfy “4” which is the constriction condition.

Data output means 124 outputs these output data as an object code.

Next, description will be given of how parallel operation device 140 is operated by an object code generated by data processing device 120 of the present invention, in comparison with the operation of parallel operation device 140 which is operated by an initial object code.

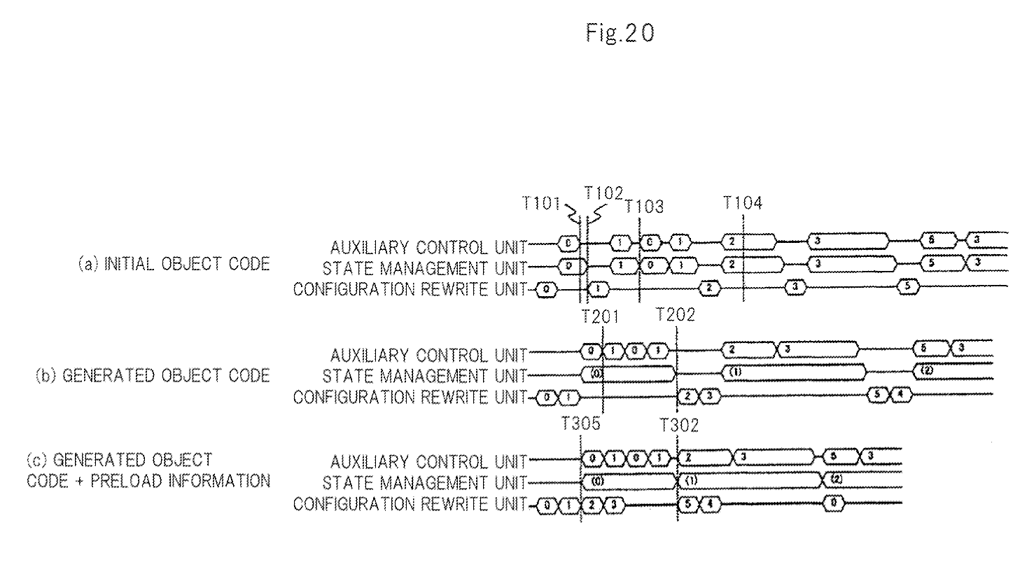

FIG. 20 includes timing charts showing several ways in which parallel operation device 140 shown in FIG. 3 is operated.

FIG. 20(a) shows how parallel operation device 140 is operated by the initial object code shown in FIG. 11, and FIG. 20(b) shows how parallel operation device 140 is operated by the object code generated by data processing device 120 of the present invention (the macro state transition graph in FIG. 18). Also, FIG. 20(c) shows how parallel operation device 140 is operated when the preload information generated by data processing device 120 of the present invention is applied to rewrite determination unit 330 when parallel operation device 140 is operated by the object code generated by data processing device 120 of the present invention.

Specifically, FIGS. 20(a)-20(c) show operational states of auxiliary control unit 321, state management unit 311, and configuration rewrite unit 314 which form part of parallel operation device 140. Also, auxiliary control unit 321 and state management unit 311 shown in FIGS. 20(a)-20(c) present logic numbers of their respective control states, while configuration rewrite unit 314 presents a logic number of a state corresponding to configuration information which is being rewritten. Note that numbers controlled by state management unit 311 shown in FIG. 20(b) and FIG. 20(c) are macro state numbers. Here, macro state numbers are shown in parenthesis for distinguishing a logic number of a state from a macro state number.

As shown in FIG. 20(a), when parallel operation device 140 is operating in line with the initial object code, the state managed by auxiliary control unit 321 is the same as the state managed by state management unit 311, so that if a transition is made to a different state in auxiliary control unit 321, processor 320 including auxiliary control unit 321 temporarily stops transferring control to state management unit 311 (T101). This temporary stoppage does not arise for a transition to the same state (T104).

Also, when a state transition occurs in state management unit 311, but configuration information storage unit 313 does not store configuration information corresponding to the state to which the transition is made, configuration number conversion unit 312 requests configuration rewrite unit 314 for the configuration information, and state management unit 311 temporarily stops until configuration rewrite unit 314 completes a rewrite of the configuration information (T102).

This temporary stoppage does not arise when configuration information storage unit 313 has stored configuration information corresponding to a state to which a transition is made (T103).

As shown in FIG. 20(b), when parallel operation device 140 is operating in line with the object code generated by data processing device 120 of the present invention, a state managed by auxiliary control unit 321 is represented by a micro state number, while a state managed by state management unit 311 is represented by a macro state number, so that auxiliary control unit 321 transfers the control to state management unit 311 only when a state transition is not included in micro state transitions. As such, state management unit 311 is free from the temporary stoppage associated with the state transition of auxiliary control unit 321, which has occurred at T101 (T201).

Further, as shown in FIG. 20(c), when parallel operation device 140 is operating in line with the object code generated by data processing device 120 of the present invention and the preload information, rewrite determination unit 330 performs a preload as appropriate based on the preload information (T305). Accordingly, upon occurrence of a state transition in state management unit 311, if configuration information storage unit 313 does not store configuration information corresponding to a state to which a transition is made, the configuration information is requested in advance of a request, which is made in rewrite determination unit 330, for the configuration information issued from configuration number conversion unit 312 to configuration rewrite unit 314. As such, state management unit 311 is free from the temporary stoppage caused by waiting for the completion of writing the configuration, as has occurred at T102 and T202 (T302).

Data processing device 120 of the present invention has been previously registered having constriction conditions that correspond to the physical structure and physical properties of the parallel operation device, generates an object code for parallel operation device 140 to operate more efficiently, from an initial object code comprised of an initial state transition graph and input to parallel operation device 140, and information related to state transitions of the same, based on the constriction conditions, and outputs this generated object code. It is therefore possible to generate an object code for a parallel operation device which is configured so that it can control multi-layer state transitions.

In parallel operation device 140 of the present invention, an object code generated by the data processing device of the present invention is stored in external storage means 304, such that processing unit 322 operates in correspondence to micro state transitions of the object code, while control unit 310 operates in correspondence to a macro state transition of the object code. Thus, in parallel operation device 140, a plurality of processing circuits can operate in parallel for every operation cycle in accordance with the object code generated by data processing device 120.

Also, in another parallel operation device 140 of the present invention, an object code generated by data processing device 120 and preload information are stored in external storage means 340, such that processing unit 322 operates in correspondence to a micro state transition of the object code, control unit 310 operates in correspondence to a macro state transition of the object code, and rewrite determination unit 330 operates in correspondence to the preload information. Thus, in parallel operation device 140, a plurality of processing circuits can operate in parallel for every operation cycle in accordance with the object code generated by data processing device 120.

Further, another parallel operation device 140 of the present invention is supplied with an object code generated by data processing device 120 and preload information, such that processing unit 322 operates in correspondence to a micro state transition of the object code, control unit 310 operates in correspondence to a macro state transition of the object code, and the rewrite determination unit operates in correspondence to the preload information. Thus, in the parallel operation device, a plurality of processing circuits can operate in parallel for every operation cycle in accordance with the object code generated by the data processing device.

Also, in the data processing system of the present invention, parallel operation device 140 is supplied with either an object code generated by data processing device 120 or preload information, or both an object code generated by data processing device 120 and preload information, where parallel processing can be executed for every plural cycles by sequentially switching processors 322 contained in parallel operation device 140 in correspondence to an initial object code input to data processing device 120.

Notably, a variety of means which make up the data processing system of the present invention are only required to implement their respective functions, and permit, for example, dedicated hardware for implementing predetermined functions, a data processing device for implementing predetermined functions by executing processing in accordance with a program, predetermined functions implemented inside of a data processing device by a program, a combination of these, and the like. Also, a variety of means which make up the data processing system of the present invention need not to be independent of one another, and permit a configuration in which certain means is part of another means.

While the present invention has been described above with reference to embodiments, the present invention is not limited to the aforementioned embodiments. The present invention can be modified in configuration and details in various manners which can be understood by those skilled in the art to be within the scope of the present invention.

This application claims the priority under Japanese Patent Application No. 2007-259889 filed Oct. 3, 2007, the disclosure of which is incorporated herein by reference in its entirety.

1-13. (canceled)

14. A data processing device for generating an object code supplied to a parallel operation device comprising a plurality of processors and a cross connection unit for switching connections of said processors, said parallel operation device configured to vary the configuration of a circuit including said processors and said cross connection unit to execute a plurality of processing operations in accordance with the object code comprised of operational instructions for said processors and at least one piece of configuration information including information indicative of a connection relationship of said processors, said data processing device comprising:
condition storage means for holding a constriction condition corresponding to a physical structure and physical properties of said parallel operation device;
data input means for acquiring the object code comprised of single-layer state transitions;
object code conversion means for generating an object code comprised of multi-layer state transitions from the object code acquired by said data input means, based on the constriction condition; and
data output means for outputting an object code generated by said object code conversion means and comprised of the multi-layer state transitions,
wherein said parallel operation device comprises:
a control unit for varying the configuration of said circuit including said processors and said cross connection unit, based on state transitions which present a transition relationship between the pieces of configuration information; and
an auxiliary control is unit interposed between said processors and said cross connection unit and said control unit for controlling state transitions which are smaller in scale than state transitions which can be controlled by said control unit,
said object code conversion means divides a state transition on the object code comprised of single-layer state transition into state transitions of smaller scale while permitting the state transitions to overlap one another, and
said division of the state transition is such a division that reduces transitions between divided state transitions.

15. The data processing device according to claim 14, wherein said object code conversion means comprises:
loop extraction means for extracting a state transition which forms part of a loop structure from a state transition graph included in the object code comprised of single-layer state transitions and information related to state transitions;
loop prioritization means for giving a priority to the state transition extracted by said loop extraction means in accordance with a characteristic of the loop structure;
group candidate extraction means for selecting a loop structure corresponding to the constriction condition from the prioritized loop structures, and extracting a group list which is a state transition graph on another layer; and
macro state transition generation means for covering a state transition graph included in the object code comprised of single-layer state transitions using the group list to generate an object code comprised of multi-layer state transitions.

16. The data processing device according to claim 15, wherein said object code conversion means comprises:
preload information generation means for generating preload information for requesting configuration information corresponding to a state to which said parallel operation device is predicted to transition subsequent to a state to which said parallel operation device next transitions, using the state transition graph included in the object code comprised of single-layer state transitions and a multi-layer state transition graph included in the object code comprised of multi-layer state transitions.

17. A data processing method for generating an object code supplied to a parallel operation device comprising a plurality of processors and a cross connection unit for switching connections of said processors, said parallel operation device configured to vary the configuration of a circuit including said processors and said cross connection unit to execute a plurality of processing operations in accordance with the object code comprised of operational instructions for said processors and at least one piece of configuration information including information indicative of a connection relationship of said processors, said data processing method comprising:
holding a constriction condition corresponding to a physical structure and physical properties of said parallel operation device in condition storage means;
acquiring the object code comprised of single-layer state transitions; and
generating and outputting an object code comprised of multi-layer state transitions from the acquired object code based on the constriction condition,
wherein said parallel operation device comprises:
a control unit for varying the configuration of a circuit made up of said processors and said cross connection unit based on state transitions which present a transition relationship between the pieces of configuration information; and
an auxiliary control unit interposed between said processors and said cross connection unit and said control unit for controlling state transitions which are smaller in scale than state transitions which can be controlled by said control unit,
a state transition on the object code comprised of single-layer state transition is divided into state transitions of a smaller scale while permitting the state transitions to overlap one another, and
said division of the state transition is such a division that reduces transitions between divided state transitions.

18. The data processing method according to claim 17, comprising:
extracting a state transition which forms part of a loop structure from a state transition graph included in the object code comprised of single-layer state transitions and information related to state transitions;
giving priority to the extracted state transition in accordance with a characteristic of the loop structure;
selecting a loop structure corresponding to the constriction condition from the prioritized loop structures, and extracting a group list which is a state transition graph on another layer; and
covering a state transition graph included in the object code comprised of single-layer state transitions using the group list to generate an object code comprised of multi-layer state transitions.

19. The data processing method according to claim 18, comprising:
generating preload information to request configuration information corresponding to a state to which said parallel operation device is predicted to transition subsequent to a state to which said parallel operation device next transitions, using the state transition graph included in the object code comprised of single-layer state transitions and a multi-layer state transition graph included in the object code comprised of multi-layer state transitions.

20. A program for causing a data processing device to generate an object code supplied to a parallel operation device comprising a plurality of processors and a cross connection unit for switching connections of said processors, said parallel operation device configured to vary the configuration of a circuit including said processors and said cross connection unit to execute a plurality of processing operations in accordance with the object code comprised of operational instructions for said processors and at least one piece of configuration information including information indicative of a connection relationship of said processors, said program causing said data processing device to:
hold a constriction condition corresponding to a physical structure and physical properties of said parallel operation device in condition storage means;
acquire the object code comprised of single-layer state transitions;
generate and output an object code comprised of multi-layer state transitions from the acquired object code based on the constriction condition,
wherein said parallel operation device comprises:
a control unit for varying the configuration of a circuit made up of said processors and said cross connection unit based on state transitions which present a transition relationship between the pieces of configuration information; and
an auxiliary control unit is interposed between said processors and said cross connection unit and said control unit for controlling state transitions which are smaller in scale than state transitions which can be controlled by said control unit,
a state transition on the object code comprised of single-layer state transition is divided into state transitions of smaller scale while permitting the state transitions to overlap one another, and
said division of the state transition is such a division that reduces transitions between divided state transitions.

21. The program according to claim 20, configured to:
extract a state transition which forms part of a loop structure from a state transition graph included in the object code comprised of single-layer state transitions and information related to state transitions;
give priority to the extracted state transition in accordance with a characteristic of the loop structure;
select a loop structure corresponding to the constriction condition from the prioritized loop structures, and extract a group list which is a state transition graph on another layer; and
cover a state transition graph included in the object code comprised of single-layer state transitions using the group list to generate an object code comprised of multi-layer state transitions.

22. The program according to claim 21, configured to:
generate preload information for requesting configuration information corresponding to a state to which said parallel operation device is predicted to transition subsequent to a state to which said parallel operation device next transitions, using the state transition graph included in the object code comprised of single-layer state transitions and a multi-layer state transition graph included in the object code comprised of multi-layer state transitions.

23. A recording medium having stored thereon a program according to claim 20.

24. A parallel operation device comprising:
a plurality of processors;
a cross connection unit for switching connections of said processors; and
external storage means for storing the object code generated by the data processing device according to claim 14,
wherein said parallel operation device executes a variety of processing operations in accordance with an object code comprised of operational instructions for said processors and at least one piece of configuration information including information indicative of a connection relationship of said processors.

25. A parallel operation device comprising a plurality of processors and a cross connection unit for switching connections of said processors,
wherein said parallel operation device is applied with an object code generated by the data processing device according to claim 14, and executes a variety of processing operations in accordance with the object code comprised of operational instructions for said processors, and at least one piece of configuration information including information indicative of a connection relationship of said processors.

26. A data processing system comprising:
the data processing device according to claim 14; and
a parallel operation device comprising a plurality of processors and a cross connection unit for switching connections of said processors,
wherein said parallel operation device is applied with an object code generated by said data processing device, and executes a variety of processing operations in accordance with the object code comprised of operational instructions for said processors, and at least one piece of configuration information including information indicative of a connection relationship of said processors.
